(19) United States
(12) Patent Application Publication
(10) Pub. No.: US 2002/0018051 A1
(43) Pub. Date: Feb. 14, 2002

(54) APPARATUS AND METHOD FOR MOVING OBJECTS ON A TOUCHSCREEN DISPLAY

(76) Inventor: MONA SINGH, CARY, NC (US)

Correspondence Address: David E. Bennett, Coats & Bennett, 1400 Crescent Green, Suite 300, Cary, NC, 27511, US

(21) Appl. No.: 09/153,701

(22) Filed: Sep. 15, 1998

(51) Int. Cl. G09G 5/00

(52) U.S. Cl. 345/173

(57) ABSTRACT

An apparatus and method for moving an object on a touchscreen display of a portable intelligent communications device or a separate computer is disclosed as including the steps of touching first and second areas on the display screen associated with the object to select the object, and identifying a new location for the object on the display screen. The object is selected when the first and second areas are touched within a predetermined time period, and moved to the new location when the location is identified on the screen within an additional predetermined time period. In touching the areas associated with an object to select the object, the screen is contacted at first and second points within a selection range about the object. From these points, the touches move in unison towards the center of the object, terminating at a point abutting or inside the periphery of the object. The first and second touches may be on opposite sides of the object and accomplished using a thumb and finger.

### BACKGROUND OF THE INVENTION

1. Field of the Invention

The present invention relates generally to a computer-controlled touchscreen display and, more particularly, to an apparatus and method for moving objects between distinct locations on a touchscreen display of a portable intelligent communications device or a separate computer.

2. Description of Related Art

Various types of computer-based devices have been developed for communications, information processing and other purposes. Among these devices are personal computers, personal digital assistants, and a relatively new class of devices known as portable intelligent communications devices. Unlike the first two devices, the portable intelligent communications device is designed extensively to be a communications device, rather than just a mobile computer, and as such it includes a computer integrated with communications hardware and software to provide telephony, messaging and information services. To enable at least some of these features, the portable intelligent communications device is able to be connected to the Internet by either a wired link or a wireless link. It will also be understood that certain software applications are provided within the portable intelligent communications device which facilitate the aforementioned features, as well as other desirable features such as a Personal Information Manager (PIM), games and the like. An exemplary portable intelligent communications device is shown and disclosed in a patent application entitled “Switching Of Analog Signals In Mobile Computing Devices” and having Ser. No. 08/796,119, which is owned by the assignee of the present invention and is hereby incorporated by reference.

Portable intelligent communications devices, like other computer-controlled devices, include a screen or display panel to enable interaction with the computer via a graphical user interface. This interaction is oftentimes accomplished by way of a mouse or other pointing device. To input or select information from the screen, the user manipulates the mouse to direct a cursor to an appropriate area of the screen. Once at the appropriate area, the user selects an item by using a mouse button, or enters a command or text through a keyboard.

In addition to inputting and selecting information, oftentimes it is desirable to move objects such as icons, control tabs and text fields to new locations on the screen. In a mouse-based system, such as a Windows® graphical user interface, objects are moved to new screen locations using a drag and drop sequence. In this sequence, the cursor is positioned over the object to be moved, and the object is selected by pressing and holding down a mouse button. While the button is held down, the cursor and object are “dragged” to the new location on the display screen. At the new location, the mouse button is released to complete the move.

In an alternative method, an object is moved to a new screen location by first selecting a drag and drop mode from a control panel. Once in the drag and drop mode, the cursor is moved to the desired object, and the mouse “clicked” to select the object. The cursor is then moved to the new target location, and the mouse “clicked” again to move the object to that location. After the object is moved, the cursor must again be directed to the control panel to deselect and exit the drag and drop mode.

While the drag and drop procedures described above are satisfactory for moving objects in mouse-based systems, these procedures do not translate intuitively to a touch-based system in which a user interacts with the computer by touching designated areas on the display screen with a finger tip. In a touch-based system, moving objects by the primary drag and drop method described above leads to ambiguity and error since the user's view of the screen is oftentimes obstructed by the user's own hand during the drag motion. Furthermore, the single touch required to select and move an object is similar to actions utilized for executing other screen tasks and therefore can be misinterpreted, leading to the unintentional moving of objects. While the alternative drag and drop method described above eliminates some of these problems, it too is undesirable since users frequently forget to exit the drag and drop mode after a move sequence, resulting in the unintentional moving of objects.

Accordingly, it is a primary object of the present invention to provide an apparatus and method for moving objects on a touchscreen display that is intuitive for the modality of touch.

It is another object of the present invention to provide an apparatus and method for moving objects on a touchscreen display in which objects are selected with a distinct manual gesture, thereby virtually eliminating confusion between a move action and other screen tasks.

It is still another object of the present invention to provide an apparatus and method for moving objects on a touchscreen display which eliminates the need to drag a selected object to the new location on the screen display.

Yet another object of the present invention is to provide an apparatus and method for moving an object on a touchscreen display of a portable intelligent communications device in which the target location for the object may be identified with a single touch.

These objects and other features of the present invention will become more readily apparent upon reference to the following description when taken in conjunction with the following drawings.

### SUMMARY OF THE INVENTION

In accordance with a first aspect of the present invention, a method of moving an object depicted on a touchscreen display of a portable intelligent communications device or other computer-controlled device is disclosed as including the steps of selecting an object having an initial location on the touchscreen display by touching an area associated with the object in a predetermined manner, identifying a target location for the object on the touchscreen display, and moving the object from the initial location to the target location. The object is moved when the target location is identified within a predetermined time period after the object has been selected. The object is also identified as being selected and the target location as being allowed for the object prior to movement of the object. The object may be selected in one of several manners, including touching first and second areas on the touchscreen display associated with the object, touching the touchscreen display in a circular motion substantially about a perimeter of the object, simultaneously touching the object and the target location on the touchscreen display, and touching a corner of the object and moving diametrically thereacross to an opposite corner thereof.

In accordance with a second aspect of the present invention, a portable intelligent communications device is disclosed as including circuitry for performing telephony operations, a processing circuit, a memory circuit, and a touchscreen display coupled to the processing circuit for controlling the display. The processing circuit is operable to move the location of objects on the touchscreen display upon detection of a predetermined tactile gesture on the touchscreen display in an area associated with one of such objects followed by a subsequent touch at a new location on the touchscreen display. An object is moved to the new location when the predetermined tactile gesture selecting the object and the subsequent touch occur within a predetermined time period. The predetermined tactile gesture to select an object may be first and second touches by a thumb and finger on opposite sides of the object, a circular motion with a finger about the object's perimeter, simultaneously touching the object and the new location on the touchscreen display, and touching a corner of the object and moving diametrically thereacross to an opposite corner thereof.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a perspective view of a portable intelligent communications device in accordance with the present invention;

FIG. 2 is a block diagram of the major components of the portable intelligent communications device depicted in FIG. 1;

FIG. 3 is a block diagram of the software architecture for the portable intelligent communications device depicted in FIGS. 1 and 2;

FIG. 4 is an exemplary screen display from a representative software application depicting an object being selected for movement to a new location on the screen display, as well as the identification of such new location for the object in accordance with the present invention;

FIG. 5 is an exemplary screen display similar to FIG. 4, depicting the selected object at the target location following movement from its original location;

FIG. 6 is a diagrammatic view of an object being selected for movement in accordance with the present invention;

FIG. 7 is a diagrammatic view of an alternative method for selecting an object to be moved in accordance with the present invention;

FIG. 8 is a diagrammatic view of another alternative method for selecting an object to be moved in accordance with the present invention; and

FIG. 9 is a flowchart of the steps by which a preferred method of the present invention is accomplished.

### DETAILED DESCRIPTION OF THE INVENTION

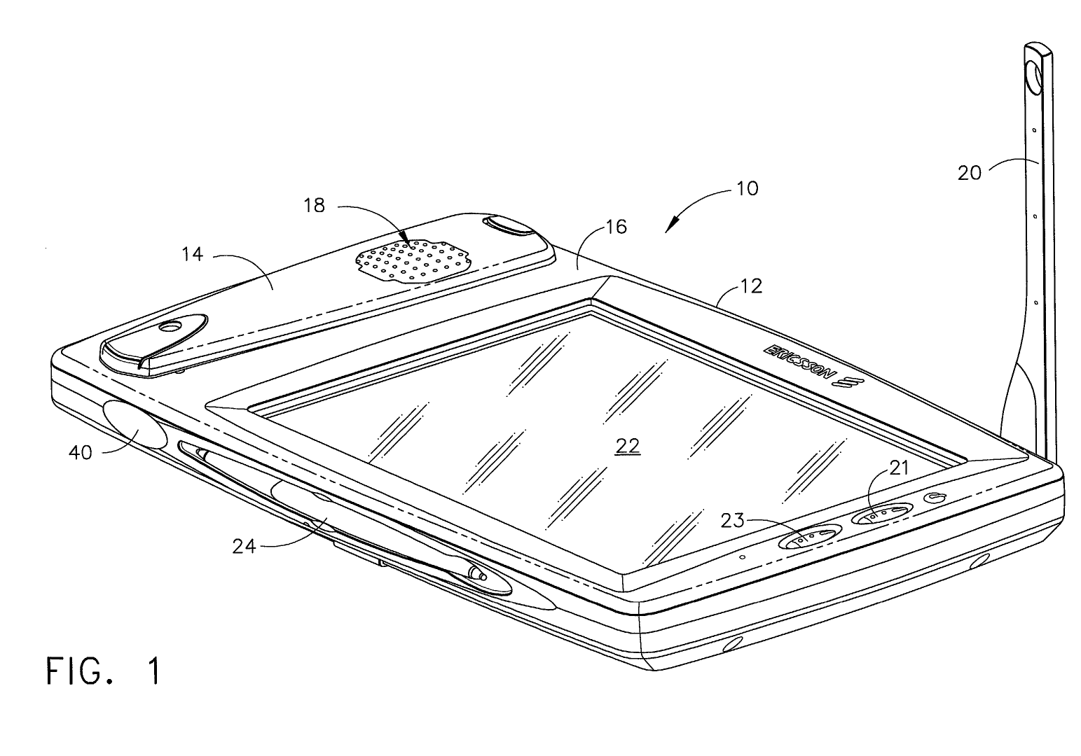

Referring now to the drawings in detail, wherein identical numerals indicate the same elements throughout the figures, FIG. 1 depicts a portable intelligent communications device identified generally by the numeral 10. It will be understood that portable intelligent communications device 10 is principally a communications device and includes circuitry and components which allows it to function in such capacity through cellular, landline, infrared data association (IrDA), phone cards, and other modes. Portable intelligent communications device 10 also includes circuitry which enables it to function in the capacity of a computer, and a plurality of software applications may be utilized therewith. Because of this combination, portable intelligent communications device 10 is uniquely suited to interface software applications with communications hardware and software, particularly where connection to an Internet address is desired. In this regard, it will be understood that portable intelligent communications device 10 generally operates in accordance with a device shown and described in a patent application entitled “Switching Of Analog Signals In Mobile Computing Devices” and having Ser. No. 08/796,119, which is also owned by the assignee of the present invention and is hereby incorporated by reference.

As seen in FIG. 1, portable intelligent communications device 10 includes a casing 12 for housing the communications and other circuitry as will be discussed in greater detail hereinafter. A handset 14 is positioned within a top portion 16 of casing 12 and preferably includes a built-in speaker 18 for use when handset 14 is maintained therein. A pivotable antenna 20 (shown in FIG. 1 in the open or use position) is provided to enable a communications function, as when portable intelligent communications device 10 is in a cellular mode of operation. It will be understood that various ports, jacks, and interfaces will be provided to further enable communications functions by portable intelligent communications device 10. Control buttons 21 and 23 are also shown as being located on top portion 16 of casing 12.

Portable intelligent communications device 10 further includes a display screen 22, which preferably is a type in which a user of the device is able to interact through touching designated areas thereon. It will be appreciated that a stylus 24 may optionally be utilized to indicate a particular area more specifically than can be accomplished with the user's finger, although most designated areas are sized for touch interaction by a typically sized finger. Since portable intelligent communications device 10 preferably is no larger than a standard business desk telephone, display screen 22 is sized to be approximately eight (8) inches measured diagonally across. This puts screen display 22 in a distinct size class, as it is smaller than normal monitor sizes for personal and portable computers and larger than screen displays for personal digital assistants (PDAs), calculators, and other similar personal electronic devices.

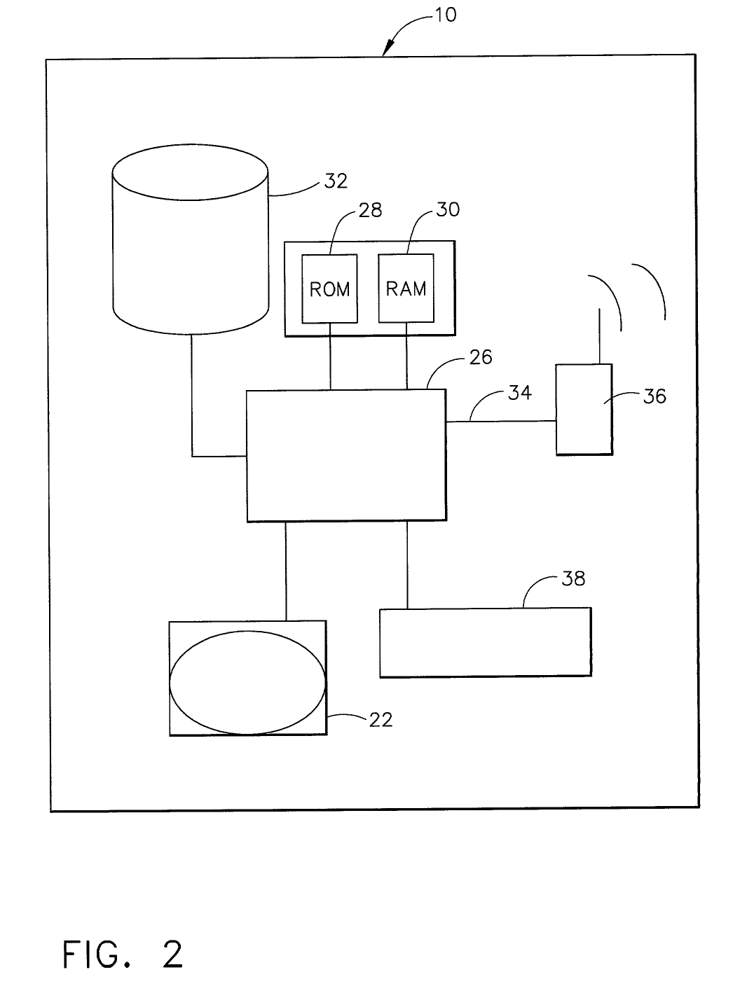

FIG. 2 depicts the internal circuitry of portable intelligent communications device 10 as including a processing circuit 26, which may, for example, be a Motorola microprocessor known by the designation Power PC 821. It will be seen that processing circuit 26 is connected to both Read Only Memory (ROM) 28 and Random Access Memory (RAM) 30 in which both operating systems and software applications are stored. An optional bulk storage device 32 is further provided for storing databases. Processing circuit 26 is also coupled to display screen 22 through a standard driver (not shown) in order to control the images displayed thereon, as well as receive information through graphical user interfaces in which the user of portable intelligent communications device 10 may indicate chosen options. The communications functions of portable intelligent communications device 10 are also handled through processing circuit 26 via a serial and/or parallel port 34 to the particular circuitry of a communications mode designated generically by reference numeral 36. As noted hereinabove, there are several communication mode options available, including cellular, landline, IrDA, and phone cards, and it will be appreciated that more than one such option may be utilized at a given time. A keyboard 38 may also be connected to processing circuit 26, where keyboard 38 can be depicted on display screen 22 or be a separate physical package which can be utilized with portable intelligent communications device 10 such as through a keyboard IR port 40 (see FIG. 1).

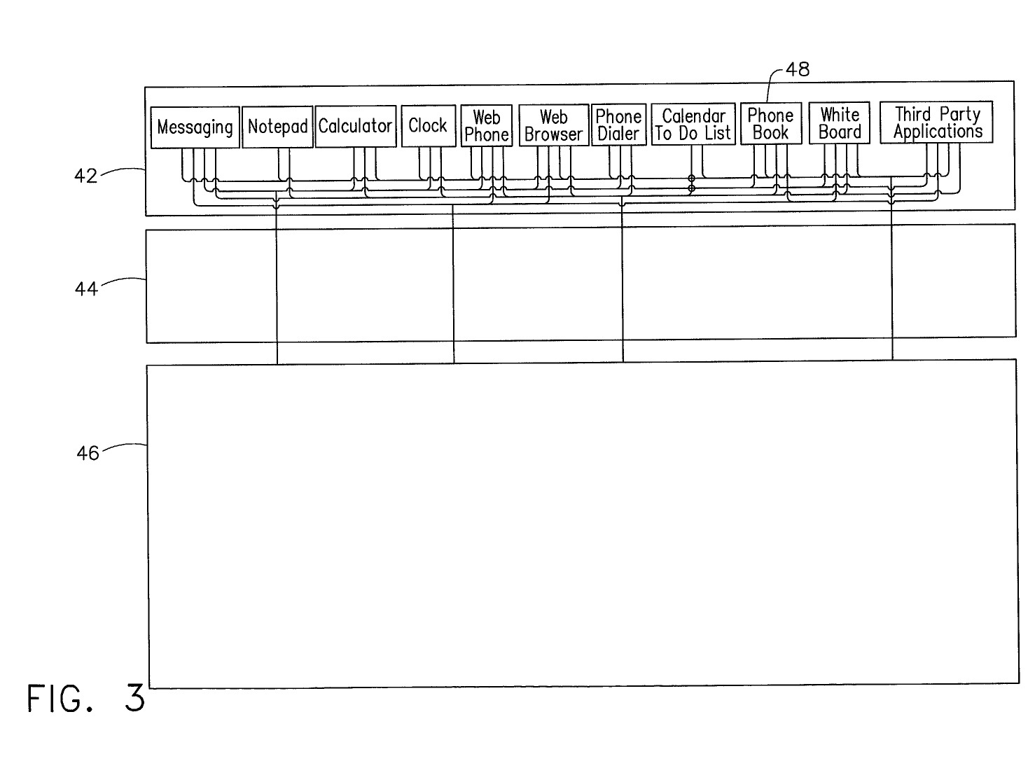

FIG. 3 depicts a schematic block diagram of the software architecture for portable intelligent communications device 10. As seen therein, the software is divided into three basic areas: applications software 42, desktop software 44, and system operating software 46 (which includes everything else from the class libraries down to the device drivers for portable intelligent communications device 10). It will be understood that neither applications software 42 nor desktop software 44 will ever interact with anything other than the top layer of system operating software 46. Exemplary software applications are shown within applications software 42, with particular reference being made to Phone Book software application 48.

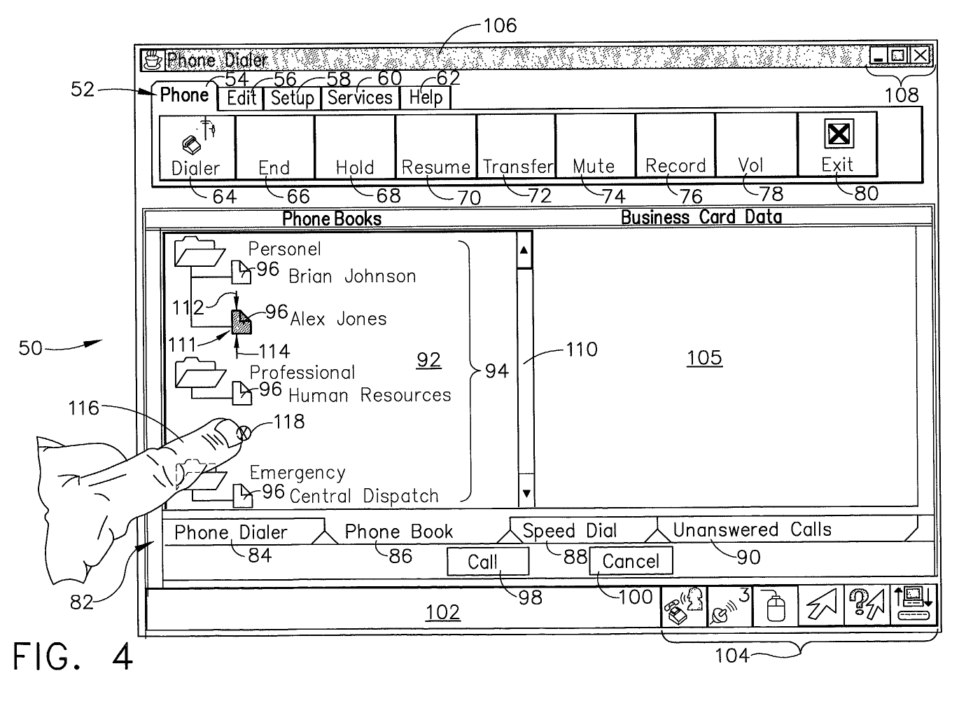

Turning now to FIG. 4, an exemplary screen display 50 is illustrated on display screen 22 when portable intelligent communications device 10 operates within Phone Book software application 48. The present invention will be described with respect to representative Phone Book software application 48, which may be used to save and group business card information on portable intelligent communications device 10 or a similar computer. It will be appreciated, however, that although the present invention is described with respect to a Phone Book software application, the invention is applicable to any touch-based user interface, such that any screen image that may be moved via a drop and drag procedure may also be moved via the pick and place method of the present invention.

As can be seen in FIG. 4, the user interface of representative screen display 50 includes a variety of screen images or objects, otherwise known as “touchable items,” through which a user interacts with the application. These touchable items include a plurality of virtual tabbed areas which make up a main control panel 52. In screen display 50, these tabbed areas are designated as “Phone” at 54, “Edit” at 56, “Setup” at 58, “Services” at 60 and “Help” at 62. A second level of objects or menu choices correspond to each of tabbed areas 54-62, and appear on display screen 22 when the corresponding tabbed area has been selected. In screen display 50, the “Phone” tabbed area at 54 has been selected, causing a second level of objects to be displayed. These objects include “Dialer” at 64, “End” at 66, “Hold” at 68, “Resume” at 70, “Transfer” at 72, “Mute” at 74, “Record” at 76, “Vol” at 78, and “Exit” at 80.

Below main control panel 52, in the lower half of screen display 50, is a second control panel 82. Control panel 82 includes the options “Phone Dialer” at 84, “Phone Book” at 86, “Speed Dial” at 88, and “Unanswered Calls” at 90, each of which may be selected by the user to perform a particular function within Phone Book software application 48. In screen display 50, the user has selected the “Phone Book” option at 86, which has brought forth a list window 92 containing a display list 94. Display list 94 includes a plurality of touchable icons 96 aligned under the group heading “Phone Books” and subheadings “Personal”, “Professional” and “Emergency.” Each of the touchable items 96 may or may not be associated with a text field which describes the depicted icon. In representative application 48, selection of any one of touchable items 96 brings forth a phone number corresponding to the individual or organization identified in the text field from memory circuits 28, 30 or 32.

Additional control buttons or objects identified as “Call” at 98 and “Cancel” at 100 are located beneath second control panel 82. Control buttons 98 and 100 may be used to initiate or terminate access to the telephony features of the portable intelligent communications device 10 using a telephone number obtained from display list 94. A bottom rectangular area 102 of screen display 50 may be used to display status information, as well as one or more additional control buttons (identified collectively by numeral 104). An additional list window or work area 105 may be provided to the right of list window 92 for entering or retrieving information related to display list 94.

In addition to the objects described above, it will be noted that screen display 50 includes a top window title bar 106 and the standard Windows-based control buttons 108 located along the right-hand side of title bar 106. A vertical scroll bar 110 is also provided for stepping through the items displayed in list window 92 when the document is too large to be displayed in its entirety therein. Scroll bar 110 preferably operates in the same manner as the equivalent vertical controls for a Windows-based program.

Each of the objects described above has a unique location on screen display 50 that is set and controlled by processing circuit 26. This location is interpreted by processing circuit 26 in determining what action to take following one or more touches on display screen 22. Although processing circuit 26 attributes a particular location to each touchable item, this location may be changed for many of the items, such as control tabs, buttons and icons, through a user initiated sequence. In the present invention, processing circuit 26 relocates an object upon detecting a touch in an area of display screen 22 associated with the object in a predetermined manner (i.e., “picking” the object), followed by the identification of a new or target location (i.e., “placing” the object).

As can be seen in FIG. 4, an object, such as that indicated by reference numeral 111, is selected or “picked” by touching the object in a predetermined manner interpreted by processing circuit 26 as requesting a movement thereof. This preferably involves touching first and second areas on object 111, as indicated by arrows 112 and 114. First touch 112 and second touch 114 are preferably on opposite sides of object 111, and is typically accomplished with a thumb and finger of a user's hand using the same motion generally made in picking up a physical object. It will be understood, however, that the touching gesture described may be done in any manner with any two separate digits of the user's hands. Preferably, first and second touches 112 and 114 occur substantially simultaneously (i.e., approximately 0.10 second), but in any event within a predetermined time period (e.g., approximately one second or less), in order for processing circuit 26 to distinguish the touches as selecting object 111 for movement, rather than another screen task. First and second touches 112 and 114 that occur outside of the predetermined time period are interpreted by processing circuit 26 as selecting the object for a different action or result in an error message indicating a failed move attempt, but in any event would not initiate movement of the object.

After object 111 has been selected, it is highlighted (see FIG. 4) to provide a visual indication to the user of its selection. Thereafter, a target location for object 111 is identified on display screen 22 in order to complete the move. In the preferred embodiment, a target location 118 for object 111 is identified by touching display screen 22 at the desired point. This generally is accomplished, as shown in screen display 50, by touching display screen 22 with a fingertip 116 at target location 118. In order for processing circuit 26 to associate the touch at target location 118 with movement of object 111, the touch preferably occurs within a predetermined time period after object 111 is selected for movement. In the preferred embodiment, the predetermined time period between selection of object 111 and identification of target location 118 is less than 2 seconds. If target location 118 is not identified within this predetermined time period, then object 111 is either automatically deselected or an error message is displayed on display screen 22 indicating a failed movement attempt. For movement of object 111 to be completed, target location 118 selected on display screen 22 must also be in an allowed area for the particular object being moved. It will be appreciated, for example, that the tabbed areas of main control panel 52 and secondary control panel 82, respectively, must remain therein and that touchable items 96 must remain within list window 94.

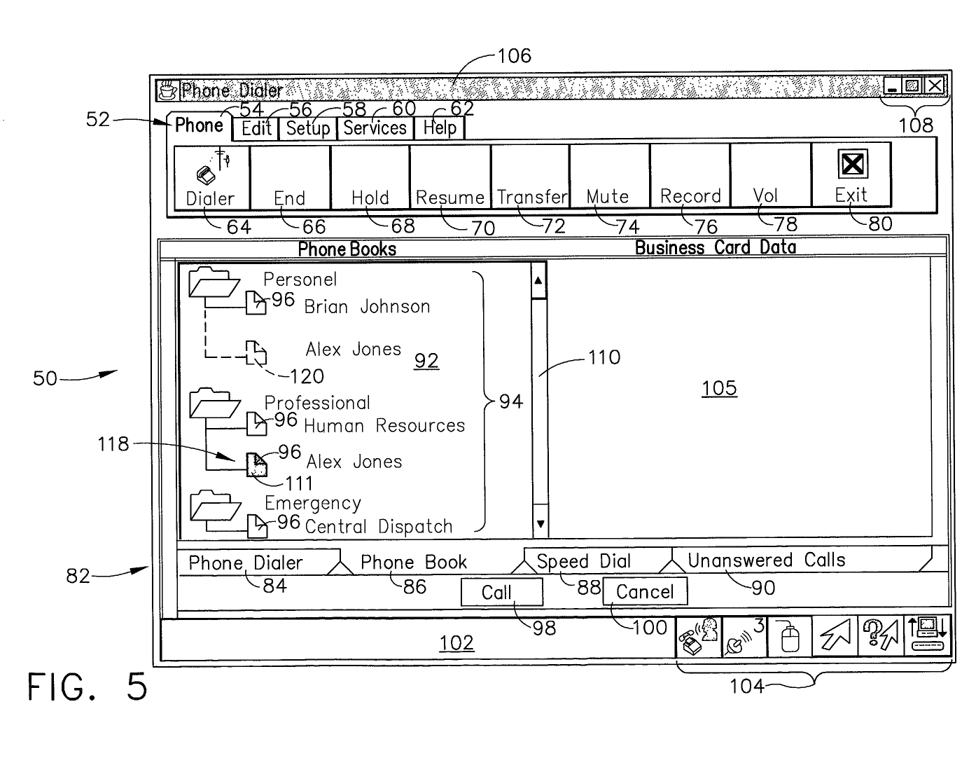

After object 111 has been “picked” as shown at 112 and 114, and target location 118 has been identified within the predetermined time period, processing circuit 26 alters display screen 22 to depict object 111 at target location 118. FIG. 5 depicts screen display 50 after object 111 has been selected and moved from its initial position under the subheading “Personal” to a new location under the subheading “Professional.” It will be understood that the initial location of object 111 is shown in dashed lines at 120, while object 111 is shown highlighted at target location 118.

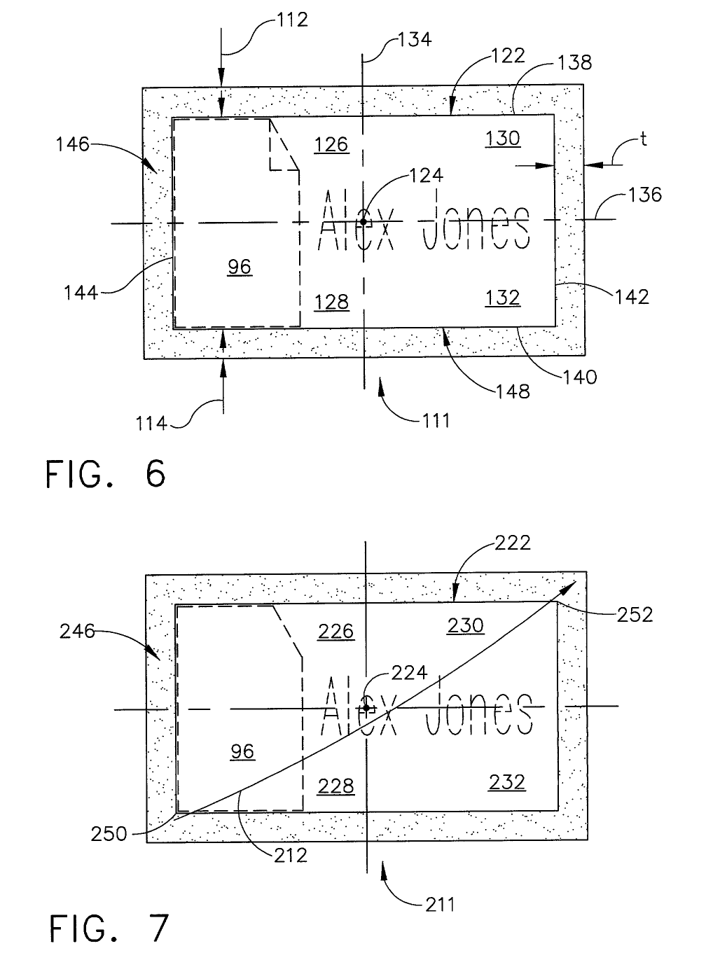

The selection of an object for a movement within a screen display will now be described in more detail with reference to FIG. 6, which is a diagrammatic view of object 111 being doubled touched as described hereinabove. As shown in FIG. 6, touchable items 96 are modeled as a rectangle 122 having a center 124 (although other shapes may be utilized). Rectangle 122 is sized to best approximate the size and shape of object 111; thus, it may be of varying dimensions with the particular dimensions thereof depending upon the modeled object. In FIG. 6, it will be appreciated that touchable item 96 and its accompanying text field “Alex Jones” are modeled as a single rectangle 122 since they are associated on screen display 50 and movable as a single object.

In rectangular model 122, object 111 is divided into four equal quadrants 126, 128, 130 and 132 by vertical center line 134 and horizontal center line 136 extending between opposing sides 138, 140 and 142, 144, respectively, through center 124. Sides 138, 140, 142 and 144 of rectangle 122 form a perimeter 148 for object 111. A border 146, shown as having a thickness t by a shaded area, surrounds rectangle 122. In the preferred embodiment, thickness t of border 146 is approximately 8-16 millimeters.

In the preferred embodiment, object 111 is selected for movement by touching rectangle 122 within first and second areas of two different quadrants. In the model shown in FIG. 6, object 111 is touched at arrows 112 and 114 along opposing longitudinal sides 138 and 140 of rectangle 122 in quadrants 126 and 128. It will be understood that object 111 could alternatively be touched substantially simultaneously at quadrants 130 and 132 or along lateral sides 142 and 144 at quadrants 126 and 130 or 128 and 132. To select object 111, the two touches preferably begin within border 146 outside of the object and move in a sliding action along display screen 22 ending on or just inside perimeter 148 of object 111. As object 111 is touched in such manner, the user's fingertips move toward each other in the direction of arrows 112 and 114 so that the distance between the two touches decreases (i.e., moves toward horizontal center line 136 of object 111). This touching action is similar to that used to pick up a physical object, and is translated in the present invention to a touchscreen display in order to impart an intuitive hand motion to movement of an object depicted thereon. As described hereinabove, after object 111 has been touched in this manner and selected, it is moved to a target location. This is accomplished provided such target location is in an allowed area for the object and it is identified by touching display screen 22 within the predetermined time period.

An alternative embodiment for selecting an object in accordance with the present invention is depicted in FIG. 7, where an object 211 is similarly modeled as a rectangle 222 having a center 224, quadrants 226, 228, 230 and 232, and a border 246. In this alternative method, the predetermined manner of selecting object 211 involves moving a human digit (preferably an index finger) from within border 246 (adjacent a first corner 250 of rectangle 222) diametrically across rectangle 222. This movement ends within border 246 adjacent an opposing second corner 252, as shown by arrow 212. In this method, only a single touch is required to select object 211, thereby eliminating the need to touch the object twice within a predetermined time period. After object 211 is selected, the target location may then be identified with a single touch on display screen 22 in order to complete the move as in the previous embodiment.

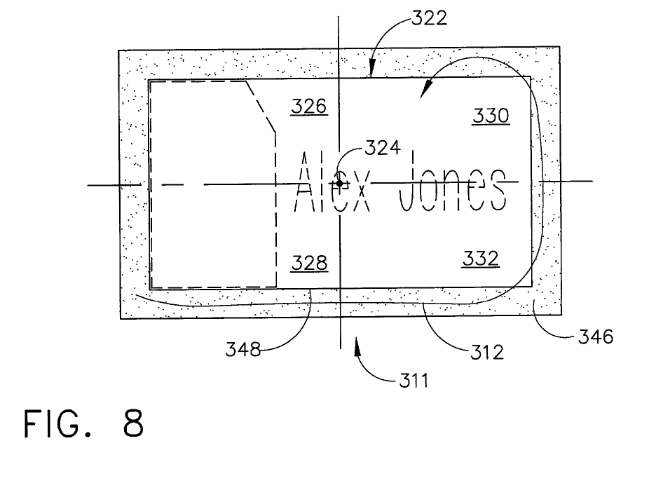

FIG. 8 depicts another alternative embodiment for selecting an object in accordance with the present invention in which an object 311 is again modeled as a rectangle 322 having a center 324, four quadrants 326, 328, 330 and 332, and a border 346. In this alternative embodiment, object 311 is selected by touching it in a circular motion substantially about the area thereof, as shown by arrow 312. More specifically, circular touch 312 preferably begins within border 346 surrounding object 311 and proceeds about perimeter 348 of object 311. Although touch 312 preferably follows border 346 around perimeter 348, it need not fall entirely within the shaded area of border 346 in order for object 311 to be selected. Following the circular motion to select object 311, movement is completed by touching the target location on display screen 22 within the aforementioned predetermined time period.

In addition to the embodiments described hereinabove, an object may be selected and moved by simultaneously touching the object and target location on display screen 22. For instance, in screen display 50 of FIG. 4, object 111 may be moved by touching object 111 with a fingertip at the same time that a second fingertip (e.g., 116) touches target location 118.

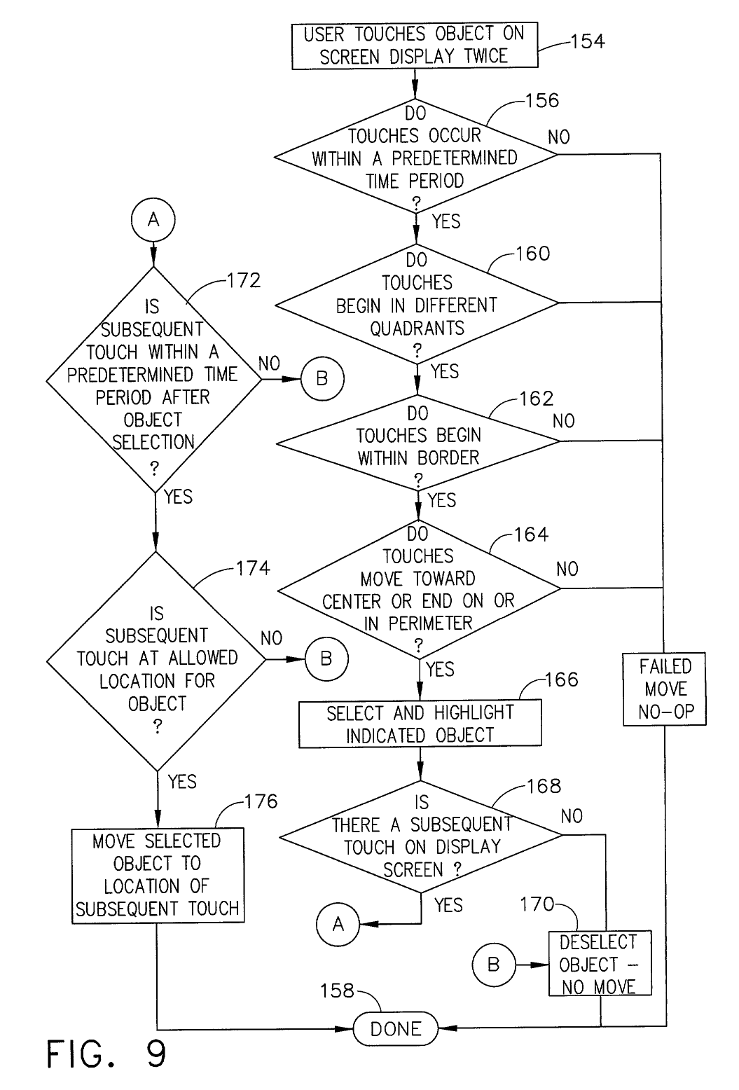

A flow chart depicting the logical steps for moving an object within display screen 22 using the touch method described herein is provided in FIG. 9. Starting at a function block 154, it will be understood that the user touches an object on opposite sides in the manner depicted in FIG. 6. After this has occurred, a decision block 156 determines whether the two touches took place within the predetermined time period. If the answer is NO at 156, then the routine is finished and it returns to step 158 without moving or selecting the object. If the answer is YES at 156, then a second decision block 160 determines whether the two touches began in different quadrants of the rectangular model. If the answer is NO at 160, then the routine is finished and it returns to step 158. If the answer at 160 is YES, then a third decision block 162 determines whether the touches began within the border surrounding the object. If the answer at 162 is NO, then the routine is finished and it returns to step 158. If the answer at 162 is YES, then a fourth decision block 164 determines whether the touches either move toward each other or end on or within the perimeter of the object. If the answer is NO at 164, the routine is finished and it returns to step 158. If the answer is YES at 164, then a function block selects the indicated object, as evidenced by highlighting or some other visual or aural manner.

After the object is selected, a decision block 168 determines whether a subsequent touch has occurred on the display screen. If the answer is NO at 168, then the object is deselected at function block 170, the routine is finished and it returns to step 158 without moving the object. If the answer is YES at 168, then a decision block 172 determines whether the subsequent touch on the display screen occurred with the predetermined time period after the object was selected. If the answer at 172 is NO, then the object is deselected at function block 170, the routine is finished and it returns to step 158. If the answer is YES at 172, then a decision block 174 determines whether the location indicated by the subsequent touch is an allowed location for the object. If the answer at 174 is NO, then the object is deselected at function block 170, the routine is finished and it returns to step 158. If the answer is YES at 174, then a function block 176 moves the selected object to the location indicated by the subsequent touch. Following movement of the object at block 176, the routine then returns to step 158.

Having shown and described the preferred embodiment of the present invention, further adaptations of the apparatus and method for moving an object on a touchscreen display can be accomplished by appropriate modifications by one of ordinary skill in the art without departing from the scope of the invention.

What is claimed is:

1. A method of moving an object depicted on a touchscreen display of a computer-controlled device, comprising the following steps:
(a) selecting an object having an initial location on said touchscreen display by touching an area associated with said object in a predetermined manner;
(b) identifying a target location for said object on said touchscreen display; and
(c) moving said object from said initial location to said target location.

2. The method of claim 1, wherein said target location is identified by touching said touchscreen display at a desired location.

3. The method of claim 1, wherein said object is moved when said target location is identified within a predetermined time period after said object has been selected.

4. The method of claim 1, wherein said object is selected by touching first and second areas on said touchscreen display associated with said object.

5. The method of claim 4, wherein said object is selected when said first and second areas are touched within a predetermined time period.

6. The method of claim 4, said selecting step further comprising:
(a) contacting first and second points on said touchscreen display adjacent said object; and
(b) moving from said first and second contact points towards a center line of said object between said contact points.

7. The method of claim 6, said first and second contact points being located outside a perimeter of said object, wherein said object is selected by moving from said first and second contact points to new points within the perimeter of said object.

8. The method of claim 6, said first and second contact points being located outside a perimeter of said object, wherein said object is selected by moving from said first and second contact points to new points within a border of said object.

9. The method of claim 7, further comprising the steps of:
(a) defining a border about the perimeter of said object; and
(b) selecting said object when said first and second contact points are within said border.

10. The method of claim 7, wherein said first and second contact points are located on opposite sides of said object.

11. The method of claim 10, wherein said first and second contact points are established by separate digits of a user's hands.

12. The method of claim 4, wherein said first and second areas are on opposite sides of said object.

13. The method of claim 11, wherein said first and second areas are touched by a thumb and finger.

14. The method of claim 5, wherein said predetermined time period is approximately one second.

15. The method of claim 6, wherein said predetermined time period is approximately two seconds.

16. The method of claim 1, further comprising the step of identifying said object as being selected prior to said moving step.

17. The method of claim 1, further comprising the step of verifying said target location as being allowed for said object prior to said moving step.

18. The method of claim 1, further comprising the step of providing a model for each object depicted on said touchscreen display.

19. The method of claim 18, wherein said models encompass each object and any associated text.

20. The method of claim 18, wherein said models are rectangular in shape.

21. The method of claim 18, wherein each model is divided into four substantially equal quadrants.

22. The method of claim 18, wherein a border is provided surrounding a perimeter of each said model.

23. The method of claim 21, said selecting step further comprising contacting said touchscreen display on opposite quadrants of said model with a pair of human digits.

24. The method of claim 23, wherein said human digits move from initial contact points toward a center line of said model.

25. The method of claim 24, wherein said motion extends from outside a perimeter of said model to inside the perimeter of said model.

26. The method of claim 24, wherein said motion begins within a specified border located outside a perimeter of said model.

27. The method of claim 1, wherein said predetermined manner of touching comprises moving a finger in a circular motion substantially about a perimeter of said object.

28. The method of claim 18, said selecting step further comprising:
(a) touching said touchscreen display on a perimeter of said model with a human digit; and
(b) moving said human digit in a circular motion substantially about said model perimeter.

29. The method of claim 1, wherein said selecting, identifying, and moving steps are accomplished by simultaneously touching said object and said target location on said touchscreen.

30. The method of claim 1, said selecting step further comprising moving a human digit diametrically across said object.

31. The method of claim 18, said selecting step further comprising:
(a) touching said touchscreen display at a first corner of said model with a human digit;
(b) moving said human digit diametrically across said model so as to intersect a center thereof; and
(c) terminating movement of said human digit at a second corner of said model opposite said first corner.

31. A portable intelligent communications device, comprising:
(a) circuitry for performing telephony operations;
(b) a processing circuit;
(c) a memory circuit; and
(d) a touchscreen display;
said processing circuit being coupled to said touchscreen display to control the depiction of objects thereon, wherein said processing circuit moves the location of an object depicted on said touchscreen display upon detection of a predetermined tactile gesture on said touchscreen display in an area associated with said object followed by a subsequent touch at a new location on said touchscreen display.

32. The portable intelligent communications device of claim 31, wherein said processing circuit operates to move the location of said object when said predetermined tactile gesture and said subsequent touch occur within a predetermined time period.

33. The portable intelligent communications device of claim 32, wherein said predetermined time period is two seconds.

34. The portable intelligent communications device of claim 32, wherein said predetermined tactile gesture on said touchscreen display comprises first and second touches on opposite sides of said object.

35. The portable intelligent communications device of claim 34, wherein said processing circuit recognizes an object as being selected for movement when said first and second touches occur within a predetermined time period.

36. The portable intelligent communications device of claim 35, wherein said predetermined time period is approximately one second.

37. The portable intelligent communications device of claim 34, wherein said first and second touches move toward a center line of said object between said touches.

38. The portable intelligent communications device of claim 34, wherein said processing circuit detects a selection of said object for movement when said first and second touches move from outside a perimeter of said object to points inside the perimeter of said object.

39. The portable intelligent communications device of claim 34, wherein said processing circuit detects a selection of said object for movement when said first and second touches move from outside a perimeter of said object to points within a border surrounding said object.

40. The portable intelligent communications device of claim 38, said processing circuit defining a border about the perimeter of said object, wherein said processing circuit detects a selection of said object for movement when said first and second touches occur within said border.

41. The portable intelligent communications device of claim 31, wherein said processing circuit identifies said object as being selected for movement prior to moving the location of said object.

42. The portable intelligent communications device of claim 31, wherein said processing circuit verifies the new location for said object as being permitted prior to moving the location of said object.

43. The portable intelligent communications device of claim 31, wherein said processing circuit provides a model for each object depicted on said touchscreen display.

44. The portable intelligent communications device of claim 43, wherein said model encompasses each object and any associated text.

45. The portable intelligent communications device of claim 43, said model for each object being divided into four substantially equal quadrants, wherein said processing circuit detects selection of an object for movement when contact on said touchscreen display on opposite quadrants of said model is recognized.

46. The portable intelligent communications device of claim 43, wherein a border is provided surrounding a perimeter of each said model.

47. The portable intelligent communications device of claim 45, wherein said contacts move toward a center line of said model therebetween.

48. The portable intelligent communications device of claim 47, wherein said motion extends from outside a perimeter of said model to inside the perimeter of said model.

49. The portable intelligent communications device of claim 47, wherein said motion begins within a specified border located outside a perimeter of said model.

50. The portable intelligent communications device of claim 45, wherein said first and second touches are made by a thumb and index finger.

51. The portable intelligent communications device of claim 31, wherein said predetermined tactile gesture on said touchscreen display comprises a circular motion substantially about a perimeter of said object.

52. The portable intelligent communications device of claim 51, wherein said processing circuit operates to move the location of said object when said circular motion and said subsequent touch occur within a predetermined time period.

53. The portable intelligent communications device of claim 31, wherein said object is selected and moved by simultaneously touching said object and said new location on said touchscreen display.

54. The portable intelligent communications device of claim 31, wherein said predetermined tactile gesture on said touchscreen display comprises moving a human digit diametrically across said object.
